(19) United States
(12) Patent Application Publication
(10) Pub. No.: US 2024/0206581 A1
(43) Pub. Date: Jun. 27, 2024

(54) ELECTRIC INK HARD HAT SYSTEM CHANGING COLOR DEPENDING ON SURROUNDING COLOR AND OPERATING METHOD

(71) Applicant: Pusan National University Industry-University Cooperation Foundation, Busan (KR)

(72) Inventors: Young-Hwan Yoo, Busan (KR); Eun young Park, Busan (KR); Jin Ho Jang, Busan (KR); DONGJU KIM, Busan (KR); Youngjin Shin, Busan (KR)

(21) Appl. No.: 18/358,938

(22) Filed: Jul. 26, 2023

(30) Foreign Application Priority Data
Dec. 21, 2022 (KR) 10-2022-0180801

(51) Int. Cl. A42B 3/04; G06T 7/90; G06V 20/52; G06V 40/10

(52) U.S. Cl. CPC A42B 3/0453; A42B 3/046; G06T 7/90; G06V 20/52; G06V 40/10; G06T 2207/10024; G06T 2207/20021; G06T 2207/30232; H04N 7/18

(57) ABSTRACT

Provided is an electric ink hard hat system that changes color depending on a surrounding color and an operating method. The electronic ink hard hat system includes a control server configured to divide a work area in a closed-circuit television (CCTV) image into a plurality of grid-shaped sections and calculate a complementary color using red, green, and blue (RGB) values in a point of interest (POI) section where a worker is located among the divided sections, a communication module configured to receive changed color information including the complementary color from the control server, and a smart hard hat configured to output an outer color of a hard hat as the complementary color using electric ink technology, based on the changed color information.

### CROSS-REFERENCE TO RELATED APPLICATIONS

This application claims the benefit of Korean Patent Application No. 10-2022-0180801 filed on Dec. 21, 2022, in the Korean Intellectual Property Office, the entire disclosure of which is incorporated herein by reference for all purposes.

### BACKGROUND

### 1. Field of the Invention

One or more embodiments relate to an electric ink hard hat system that changes color depending on a surrounding color and an operating method for securing the safety of a worker by monitoring a working environment and a dangerous situation, identifying a location of the worker and a color of a work area, finding a complementary color for each section based on corresponding information, communicating with a hard hat, and mapping to a designated color.

The electric ink hard hat system that changes color depending on a surrounding color and an operating method may prevent collision between a worker and a dangerous object in advance by distinguishing the worker and a surrounding environment from a color in a contrasting manner and may quickly respond by changing a color when a dangerous situation occurs to the worker and continuously monitoring a state of the worker.

### 2. Description of the Related Art

In Korean Registration No. 10-2359830 (Industrial Site Safety Management System and Method Using Hard Hat), an industrial site safety management system using a hard hat such that workers quickly respond to an accident by immediately notifying an accident occurred using the hard hat when an industrial accident occurs to workers who work wearing the hard hat at the industrial site is provided. Korean Registration No. 10-2359830 uses a processing device that receives data of a coordinate value and movement from a hard hat and externally transmits the data, and controls a color change of light output from the hard hat depending on a control signal. Korean Registration No. 10-2359830 identifies a current location of a worker at a working site in real-time, and when the worker enters a dangerous area, other workers or managers may immediately recognize the dangerous situation through a hard hat, so that immediate response to a dangerous accident is possible. However, Korean Registration No. 10-2359830 has disadvantages that a dangerous situation is only recognized on the front side of a hard hat in which lighting is installed and is difficult to identify the dangerous situation in a bright environment.

In Korean Registration No. 10-0494343 (Functional Hard Hat and Functional Hard Hat Accident Prevention System), for preventing heat-related illnesses depending on a working environment of a user who works at a construction site, a functional hard hat and a functional hard hat accident prevention system such that workers and managers visually and electrically recognize a situation in which the user left at a temperature dangerous to work in and take action by installing, to a hard hat, thermochromic stickers or thermo-paints that change a color depending on the temperature of the hard hat are provided. However, Korean Registration No. 10-0494343 has limitations in identifying other dangerous situations by changing a color of a hard hat by limiting a dangerous situation to a temperature.

In industrial sites, a collision accident between a worker, a vehicle, and an object in factories accounts for a large proportion of accidents. Drivers of a vehicle or forklift often fail to find workers in a working environment or fail to distinguish a color of working clothes from surrounding objects because the colors are similar to each other.

Accordingly, when a worker faces a dangerous situation by considering a surrounding environment, there is a need for an improved model that recognizes a dangerous situation and minimizes an accident from occurring by automatically changing a color of a hard hat.

### SUMMARY

Embodiments provide an electric ink hard hat system that changes color depending on a surrounding color and an operating method to easily distinguish a worker from other objects in a work area by providing a smart hard hat that automatically changes color depending on a surrounding environment of the work area where the worker works in an industrial site.

Embodiments aim to prevent a collision accident in advance by recognizing a changing color of a smart hard hat through image recognition and identifying a dangerous situation between a worker and a dangerous object in real-time.

Embodiments aim to reduce power consumption by reducing consumption power compared to light-emitting diode (LED) lighting using electric ink technology when changing a color of a smart hard hat and by identifying a color of a hard hat from all directions compared to the LED-type warning light according to the related art.

Embodiments provide a smart hard hat to which electric ink technology is applied, which adds various functions without hardware manipulation and is easy to maintain.

According to an aspect, there is provided an electric ink hard hat system including a control server configured to divide a work area in a closed-circuit television (CCTV) image into a plurality of grid-shaped sections and calculate a complementary color using red, green, and blue (RGB) values in a point of interest (POI) section where a worker is located among the divided sections, a communication module configured to receive changed color information including the complementary color from the control server, and a smart hard hat configured to output an outer color of a hard hat as the complementary color using electric ink technology, based on the changed color information.

According to an aspect, there is provided a method of operating an electric ink hard hat system including dividing a work area in a CCTV image into a plurality of grid-shaped sections by a control server, calculating a complementary color using RGB values in a POI section where a worker is located among the divided sections by the control server, receiving changed color information including the complementary color from the control server by a communication module, and outputting an outer color of a hard hat as the complementary color using electric ink technology based on the changed color information, in a smart hard hat.

Additional aspects of embodiments will be set forth in part in the description which follows and, in part, will be apparent from the description, or may be learned by practice of the disclosure.

According to embodiments, by providing a smart hard hat that automatically changes color depending on a surrounding environment of a work area where a worker works in an industrial site, an electric ink hard hat system that changes color depending on a surrounding color and an operating method to easily distinguish the worker from other objects in the work area may be provided.

According to embodiments, it is possible to prevent a collision accident in advance by recognizing a changing color of a smart hard hat through image recognition and identifying a dangerous situation between a worker and a dangerous object in real-time.

According to embodiments, using electric ink technology when changing a color of a smart hard hat, it is possible to identify a color of a hard hat from all directions compared to the LED-type warning light according to the related art and reduce power consumption by reducing consumption power compared to LED lighting.

According to embodiments, it is possible to provide a smart hard hat to which electric ink technology is applied, which adds various functions without manipulating hardware and is easy to maintain.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a configuration of an electric ink hard hat system according to an embodiment;

FIG. 2 is a diagram illustrating an example of generating a grid in a work area and displaying a section number;

FIG. 3 is a diagram illustrating recognizing a worker and a dangerous object and determining a dangerous situation using the you-only-look-once (YOLO) algorithm;

FIG. 4 is a diagram illustrating measuring red, green, and blue (RGB) values in a point of interest (POI) section and calculating a complementary color;

FIG. 5 is a diagram illustrating an example of a method of storing data, according to movement;

FIG. 6 is a flowchart illustrating implementation of an electric ink hard hat system;

FIG. 7 is a flowchart illustrating designating a complementary color; and

FIG. 8 is a flowchart illustrating an operating method of an electric ink hard hat system, according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

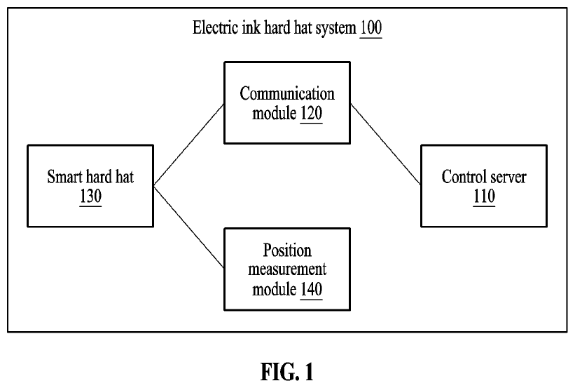

FIG. 1 is a block diagram illustrating a configuration of an electric ink hard hat system according to an embodiment.

Referring to FIG. 1, according to an embodiment, an electric ink hard hat system 100 may include a control server 110, a communication module 120, and a smart hard hat 130. According to an embodiment, the electric ink hard hat system 100 may additionally include a position measurement module 140.

First, the control server 110 may divide a work area in a closed-circuit television (CCTV) image into a plurality of grid-shaped sections. That is, the control server 110 may divide a work area where a worker works into a plurality of sections in the CCTV image of a workplace.

The control server 110 may divide a work area in the CCTV image into a plurality of sections by partitioning the work area in the horizontal and vertical directions at a regular interval like a checkerboard and may assign and display a section number to each section.

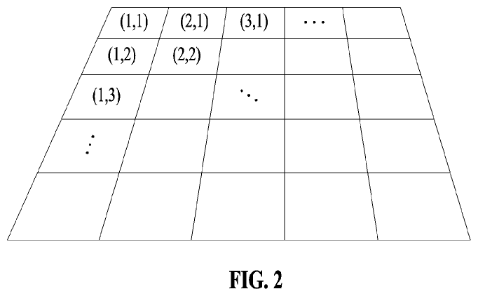

For example, the control server 110 may divide a work area in the CCTV image into a plurality of 5×5 sections and assign section numbers (1,1), (1,2), etc., for each of the divided sections (see FIG. 2).

In addition, the control server 110 may calculate a complementary color using red, green, and blue (RGB) values in a point of interest (POI) section where the worker is located among the divided sections. That is, the control server 110 may designate a section where the worker is recognized as a POI section through object recognition in the image and may determine a complementary color contrasting with a dominant color in the POI section.

In calculating the complementary color, the control server 110 may designate representative colors R, G, and B using an average RGB obtained by measuring and averaging RGB values of pixels forming the POI section.

Using a library, the control server 110 may measure RGB values for all pixels in the POI section, average each of the measured RGB values, calculate an average R, an average G, and an average B, and designate each of the average R, the average G, and the average B as the representative colors R, G, and B in the POI section.

In addition, the control server 110 may calculate a complementary color by subtracting each of the designated representative colors R, G, and B from 255 but may calculate the complementary color by rounding the representative colors R, G, and B subtracted from 255 based on 127 by considering a color of which an output is limited by electric ink technology.

That is, the control server 110 may calculate a complementary color by subtracting each of the designated representative colors R, G, and B from 255. However, since all colors may not be expressed by an electric ink, the control server 110 may round the representative colors R, G, and B subtracted from 255 based on 127.

For example, through the average RGB, when the representative colors R, G, and B in the POI section are designated, the control server 110 may compare each of the representative colors R, G, and B with 127 (R<127, G>127, and B<127), select R and B less than 127, and accordingly calculate Purple, which is a color combining R with B, as a complementary color in the POI section.

In addition, when the calculated complementary color is red and overlaps with red depending on a dangerous situation, the control server 110 may recalculate a color by combining a color of the least value among the RGB values measured for the POI section with the red as the complementary color.

That is, when the calculated complementary color is red, the control server 110 may replace and recalculate the red, which is the complementary color, to other colors to solve an overlapping problem with red that is used to express a dangerous situation. A color combined a color distributed the least in the POI section with the red may be an alternative color.

For example, only R less than 127 should be selected by comparing (R<127, G>127, and B>127) each of the representative colors R, G, and B with 127, but the control server 110 may recalculate Yellow, which is a color combining R with G, as a complementary color in the POI section by further selecting a relatively less G by comparing (G<B) G with B.

The communication module 120 may receive changed color information including a complementary color from the control server 110. That is, the communication module 120 may be installed in the smart hard hat 130, receive the changed color information created by the control server 110 from the control server 110, and transmit the changed color information to the smart hard hat 130.

The smart hard hat 130 may output an outer color of a hard hat as a complementary color using electric ink technology, based on the changed color information. That is, the smart hard hat 130 may identify the worker by changing the color of the hard hat to a color contrasting with the work area where the worker is located depending on the complementary color in the changed color information.

The electric ink technology may be technology of printing a surface of an object while changing a color using electromagnetic properties of particles. In the present disclosure, the electric ink technology may be used to change the outer color of the hard hat worn by the worker to contrast with the work area.

According to an embodiment, the electric ink hard hat system 100 may track the movement of the worker, recognize the possibility that a dangerous situation occurs, and warn the worker and people around the worker of a dangerous situation by changing and then displaying the color of the hard hat as red.

To this end, the electric ink hard hat system 100 may further include the position measurement module 140 for positioning a coordinate value of the smart hard hat 130.

The position measurement module 140 may track the movement of the smart hard hat 130 in the work area by positioning the coordinate value of the smart hard hat 130 in real-time.

The control server 110 may identify a section to which the coordinate value received through the communication module 120 belongs among the sections as the POI section. That is, the control server 110 may assign coordinate values to each of the sections and may designate a section to which the received coordinate values are assigned as the POI section.

In addition, the control server 110 may identify a change of the coordinate value received at a predetermined periodic interval, recognize the movement of the worker wearing the smart hard hat 130, and accordingly, update and identify the POI section. That is, the control server 110 may track the movement of the worker by identifying that there is a change in the received coordinate value, and accordingly, may designate the POI section while changing the POI section.

In addition, the control server 110 may determine the worker and a dangerous object in the CCTV image and identify a distance between the worker and the dangerous object, and when the identified distance is in a defined safety distance, the control server 110 may recognize a dangerous situation in the POI section and update changed color information by replacing the complementary color with red depending on the dangerous situation.

That is, when it is determined that the possibility of a dangerous situation is likely to be high as the distance between the worker and the dangerous object is close to each other through object recognition, the control server 110 may create changed color information that changes the color of the smart hard hat 130 to red by replacing a complementary color.

Then, the smart hard hat 130 may change and then output the outer color of the hard hat as red based on the updated changed color information received through the communication module 120.

That is, the smart hard hat 130 may notify the surroundings that the worker is facing a dangerous situation by changing the color of the hard hat to red indicating a dangerous situation depending on red in the changed color information.

According to an embodiment, by providing the smart hard hat 130 that automatically changes color depending on a surrounding environment of the work area where the worker works in the industrial site, the electric ink hard hat system 100 that changes a color depending on a surrounding color and an operating method to easily distinguish the worker from other objects in the work area may be provided.

In addition, according to the present disclosure, it is possible to prevent a collision accident in advance by recognizing a changing color of the smart hard hat 130 through image recognition and identifying a dangerous situation between the worker and a dangerous object in real-time.

In addition, according to the present disclosure, using the electric ink technology when changing the color of the smart hard hat 130, it is possible to identify the color of the hard hat from all directions compared to the light-emitting diode (LED)-type warning light according to the related art and reduce power consumption by reducing consumption power compared to LED lighting.

In addition, according to the present disclosure, it is possible to provide the smart hard hat 130 to which the electric ink technology is applied, which adds various functions without manipulating hardware and is easy to maintain.

The present disclosure may provide the electric ink hard hat system 100 that changes a color depending on a surrounding color and an operating method to prevent collision between the worker and a dangerous object in advance by distinguishing the color of the hard hat of the worker from a color contrasting with a surrounding environment and to quickly respond to a dangerous situation by changing the color of the hard hat when the dangerous situation occurs to the worker and by continuously monitoring a state of the worker.

The electric ink hard hat system 100 may maximize securing the safety of the worker and factory productivity by minimizing an accident from occurring by changing the color of the hard hat depending on a work area through the electric ink technology.

The electric ink hard hat system 100 may provide a safe working environment to the worker and quickly inform other workers of dangerous surroundings and the safety status of the worker.

The electric ink hard hat system 100 may secure the safety of the worker by monitoring a working environment and a dangerous situation in the control server 110, identifying a location of the worker and a color of a work area, finding a complementary color for each section based on the identified information, communicating with the hard hat, and mapping the outer color of the hard hat to a predetermined color.

The electric ink hard hat system 100 may identify the location of the worker, the color of the work area, and the dangerous situation, and transmit information by communicating with the hard hat.

The electric ink hard hat system 100 may include a control server, a smart hard hat, and a position measurement module and a communication module that are mounted on the smart hard hat.

The control server may divide a work area in a CCTV image into a plurality of grid-shaped sections.

The control server may identify a POI section where the worker is located among the divided sections and recognize a dangerous situation in the identified POI section.

The control server may measure RGB values in the identified POI section and calculate a complementary color using the measured RGB values.

The position measurement module may perform positioning a coordinate value of the smart hard hat. The position measurement module may be implemented as, for example, a global positioning system (GPS), Bluetooth beacon, and the like.

The communication module may communicate between the control server and the smart hard hat.

The position measurement module may perform positioning a coordinate value of the smart hard hat worn by the worker.

The position measurement module may perform positioning by updating the coordinate value of the smart hard hat depending on the movement of the worker when the worker moves through sections.

The communication module may communicate between the control server and the smart hard hat, receive changed color information from the control server, and transmit the changed color information to the smart hard hat.

The smart hard hat may change the outer color of the hard hat using electric ink technology.

The smart hard hat may change the color of the hard hat based on the changed color information received from the control server.

FIG. 2 is a diagram illustrating an example of generating a grid in a work area and displaying a section number.

The control server may divide a work area in a CCTV image into a plurality of grid-shaped sections.

In addition, the control server may assign a section number to each divided section.

For example, as shown in FIG. 2, the control server may divide the work area in the CCTV image into 5×5 sections, and then may assign and display section numbers such as (1,1), (1,2), etc., to each of the divided sections.

The control server may measure RGB values for each of the divided sections.

The control server may recognize the movement between the worker and a dangerous object to recognize a dangerous situation of the worker in the CCTV image.

To this end, the control server may use an object detection algorithm that recognizes the worker and the dangerous object. The object detection algorithm is one of the widely used techniques in the image processing field and may be used to classify images.

Specifically, the control server may use the you-only-look-once (YOLO) algorithm, which is one of the object detection algorithms. The YOLO algorithm may be an object detection algorithm that extracts a feature using a single conventional neural network (CNN) model and classifies image classes by calculating a bounding box.

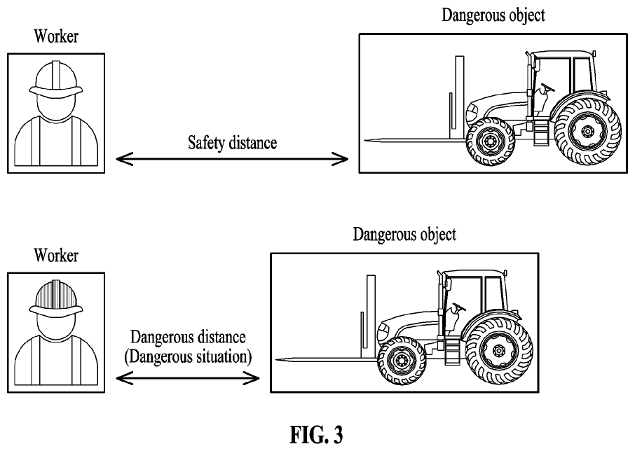

FIG. 3 is a diagram illustrating recognizing a worker and a dangerous object and determining a dangerous situation using the YOLO algorithm.

As shown in FIG. 3, the control server may detect an object from a CCTV image using the YOLO algorithm and cover the detected object, the worker and a dangerous object (e.g., a forklift) with a box.

Here, the control server may cover the worker and the dangerous object (e.g., a forklift) with a box of a different color so that the worker and the dangerous object may be distinguished from each other.

When a distance between the worker and the box covering the dangerous object is recognized decreases to be less than or equal to a dangerous distance, the control server may determine a color (red) to be transmitted to the smart hard hat to notify a dangerous situation.

The control server may determine a color that the smart hard hat has in a work area.

In determining the color of the smart hard hat, the control server may identify a POI section where the worker is located among a plurality of sections and measure RGB values in the POI section to identify colors widely distributed in the identified POI section.

Then, the control server may calculate a complementary color using the measured RGB values.

The control server may measure the RGB values in the POI section using Pillow, which is one of the Python libraries.

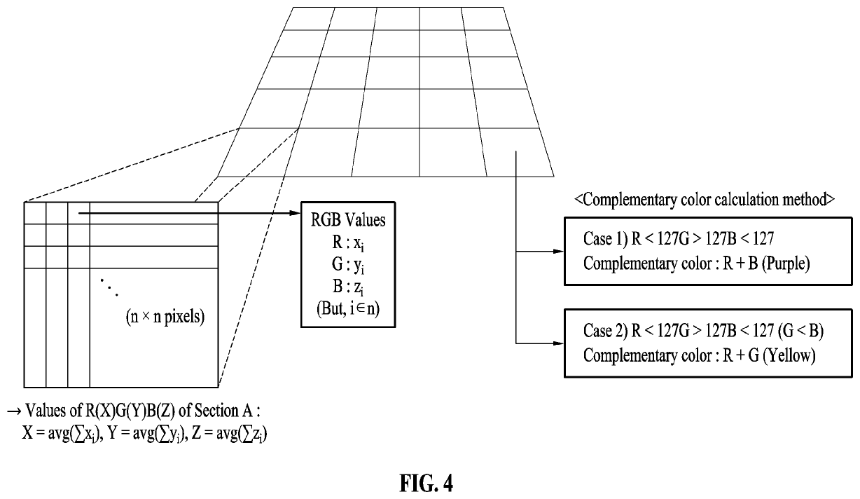

FIG. 4 is a diagram illustrating measuring RGB values in a POI section and calculating a complementary color.

The control server may measure RGB values for all pixels in a POI section using a library and calculate an average for each of the measured RGB values.

For example, as shown in FIG. 4, when section A is identified as a POI section, the control server may calculate averages (X=avg(Σxi), Y=avg(Σyi), and Z=avg(Σzi)) of the measured RGB values from (0,0) to (100,100) in pixel sections (0-100, 0-100) of the identified section A.

The control server may designate R(X), G(Y), and B(Z), which is the RBG averages, using the calculated averages X, Y, and Z as representative colors R, G, and B of the section A.

The control server may calculate a complementary color by subtracting each of the designated representative colors R, G, and B from 255. However, since all colors may not be expressed by an electric ink, the control server may round the representative colors R, G, and B subtracted from 255 based on 127.

In calculating the complementary color, for example, when the representative color R is less than 127 (R<127), the representative color G is greater than 127 (G>127), and the representative color B is less than 127 (B<127), the control server may select R and B and calculate Purple, which is generated by combining R with B, as the complementary color.

However, when red is calculated as the complementary color, the control server may calculate the complementary color by replacing the red with other colors because the red overlaps with red indicating a dangerous situation.

The control server may designate a color by combining a color distributed the least in a corresponding section among RGB values with red as an alternative color.

For example, when the representative color R is less than 127 (R<127), the representative color G is greater than 127 (G>127), and the representative color B is greater than 127 (B>127), R should be selected, but the control server may apply the fact that G is less than B (G<B), further select G and R, and calculate Yellow, which is generated by combining R with G, as a complementary color.

The position measurement module may be mounted on the smart hard hat to recognize a location of the worker.

The position measurement module may perform positioning a coordinate value of the smart hard hat.

The communication module may transmit the coordinate value obtained by positioning from the position measurement module to the control server.

The control server may identify a section number where the worker is currently located using the transmitted coordinate value.

The control server may store data including the coordinate value, the section number, and the calculated complementary color.

The format of the data to be stored may be [the hard hat number, (the coordinate value, the section number, the complementary color)].

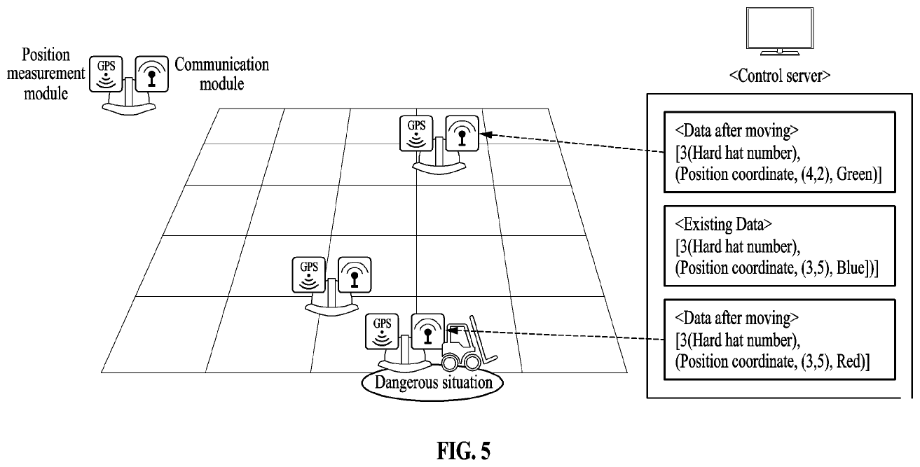

FIG. 5 is a diagram illustrating an example of a method of storing data, according to movement.

When a location of the worker changes, the following two situations may occur.

The first situation may be when a dangerous situation occurs even though the worker does not move by changing sections.

A position measurement module may perform positioning a coordinate value of a smart hard hat in real-time.

A control server may receive the coordinate value measured in real-time by the position measurement module through a communication module, analyze the coordinate value, and recognize that a dangerous situation occurs as the worker and a dangerous object are close to each other, although a section number where the worker is located has not changed.

As a dangerous situation occurs, the control server may update and store a coordinate value and a complementary color in data.

For example, when the existing data is [No3, ((latitude 37.56, longitude 126.97), (3,5), (Blue)]], as a dangerous situation occurs, the control server may update and then store the data as [No3, ((Latitude 37.55, longitude 126.98), (3,5), (Red)]].

The control server may create changed color information using the updated data.

The changed color information may be transmitted to the smart hard hat through the communication module, and the smart hard hat may change the color of the hard hat to red for a dangerous situation based on red in the changed color information.

The second situation may be when the worker moves by changing sections.

The control server may receive a coordinate value measured by the position measurement module in real-time through the communication module and recognize a section number where the worker is currently located has changed.

The control server may first identify whether there is a dangerous situation, and when there is no dangerous situation, may update data to a complementary color in the changed section number.

The control server may change and store a coordinate value and a complementary color of a section number in the data.

For example, when the existing data is [No3, ((latitude 37.56, longitude 126.97), (3,5), (Blue)]], as the section number changes, the control server may update and then store the data as [No3, ((Latitude 37.60, longitude 126.90), (4,2), (Green)]].

The control server may create changed color information using the updated data.

The changed color information may be transmitted to the smart hard hat through the communication module, and the smart hard hat may change the color of the hard hat to Green, which is a complementary color of the moved section, based on Green in the changed color information.

The smart hard hat may change the outer color of the hard hat using electric ink technology.

A display using an electric ink may be mounted on the smart hard hat.

The smart hard hat may change the color of the hard hat based on the changed color information that is transmitted through the communication module.

The smart hard hat may secure the safety of the worker in factories, distribution centers, and outdoor construction sites by distinguishing the location of the worker from the color of the work area by changing the outer color of the smart hard hat to avoid a dangerous situation.

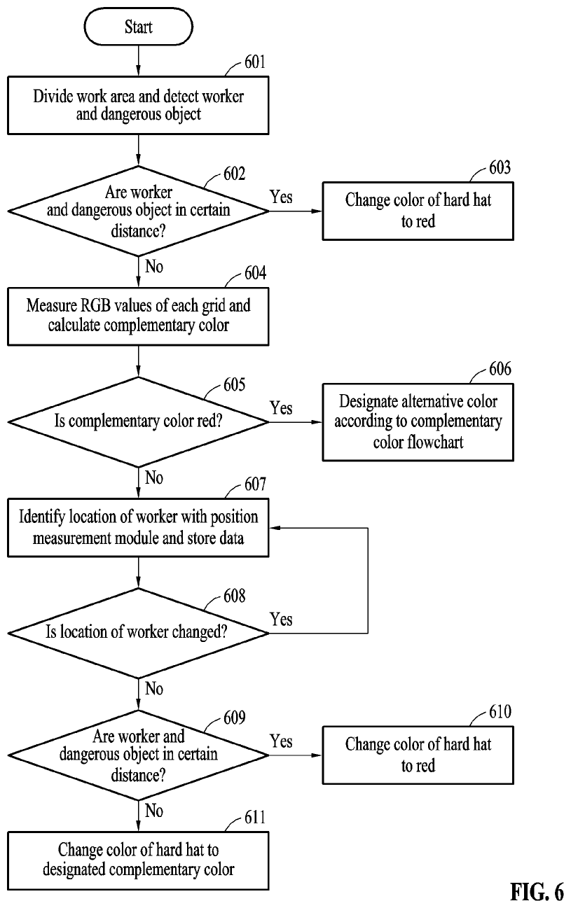

FIG. 6 is a flowchart illustrating implementation of an electric ink hard hat system.

In operation 601, the electric ink hard hat system 100 may divide a work area from a CCTV image captured and collected by a CCTV into a plurality of grid-shaped sections and may detect the worker and a dangerous object.

In operation 602, the electric ink hard hat system 100 may determine whether the worker and the dangerous object are in a certain distance.

When the distance between the worker and the dangerous object approaches a predetermined dangerous distance (the Y direction in operation 602), in operation 603, the electric ink hard hat system 100 may change the color of the hard hat of the worker to red.

Alternatively, when it is determined that the distance is safe (the N direction in operation 602), in operation 604, the electric ink hard hat system 100 may measure RGB values of each divided section (grid) and accordingly, may calculate a complementary color.

In operation 605, the electric ink hard hat system 100 may determine whether the complementary color is red.

When the complementary color is red (the Y direction in operation 605), in operation 606, the electric ink hard hat system 100 may designate an alternative color for a section in which the complementary color is determined as red in a process of calculating the complementary color.

When it is determined that the complementary color is not red (the N direction in operation 605), in operation 607, the electric ink hard hat system 100 may communicate with a position measurement module built in the hard hat, identify a location of the worker, and store data.

In operation 608, the electric ink hard hat system 100 may determine whether the location of the worker has changed.

When the location of the worker changes during communication (the Y direction in operation 608), the electric ink hard hat system 100 may return to operation 607, identify the location of the worker, and store data.

When the location of the worker has not changed (the N direction of operation 608), in operation 609, the electric ink hard hat system 100 may determine again whether the worker and the dangerous object are in a certain distance.

When the distance between the worker and the dangerous object approaches a predetermined dangerous distance (the Y direction in operation 609), in operation 610, the electric ink hard hat system 100 may change the color of the hard hat of the worker to red.

Alternatively, when it is determined that the distance is safe (the N direction in operation 609), in operation 611, the electric ink hard hat system 100 may change the color of the hard hat to a designated complementary color in a section where the worker is located.

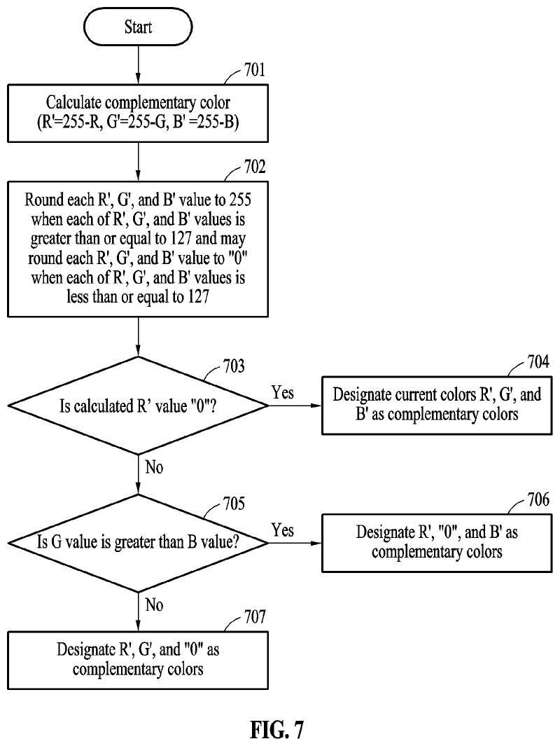

FIG. 7 is a flowchart illustrating of designating complementary color.

FIG. 7 is a flowchart in more detail of a process of calculating a complementary color in operations 604 to 606 of FIG. 6.

In operation 701, the electric ink hard hat system 100 may calculate a complementary color by subtracting from 255 for each of RGB values measured in each section (R′=255−R, G′=255−G, B′=255−B).

In operation 702, the electric ink hard hat system 100 may round each R′, G′, and B′ value to 255 when each of R′, G′, and B′ values is greater than or equal to 127 and may round each R′, G′, and B′ value to “0” when each of R′, G′, and B′ values is less than or equal to 127.

In operation 703, the electric ink hard hat system 100 may determine whether the calculated R′ value is “0”.

When the calculated R′ value is “0” (the Y direction in operation 703), in operation 704, the electric ink hard hat system 100 may designate current colors R′, G′, and B′ as complementary colors because the calculated R′ value is not close to red.

When the calculated R′ value is not “0” (the N direction in operation 703), in operation 705, the electric ink hard hat system 100 may determine whether the G value is greater than the B value.

When the G value is greater than the B value (the Y direction in operation 705), in operation 706, the electric ink hard hat system 100 may designate values R′, “0”, and B′ of R+B as complementary colors.

When the G value is not greater than the B value (the N direction in operation 705), in operation 707, the electric ink hard hat system 100 may designate values R′, G′, and “0” of R+G as complementary colors.

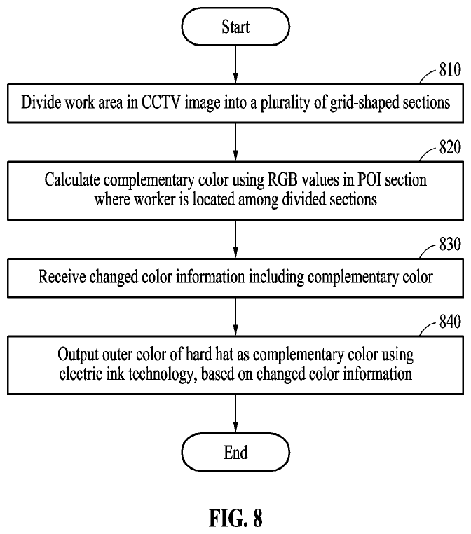

Hereinafter, FIG. 8 illustrates a flowchart of implementing the electric ink hard hat system 100 according to embodiments.

FIG. 8 is a flowchart illustrating an operating method of an electric ink hard hat system, according to an embodiment.

According to an embodiment, an operating method of an electric ink hard hat system may be performed by the electric ink hard hat system 100.

First, in operation 810, a control server of the electric ink hard hat system 100 may divide a work area in a CCTV image into a plurality of grid-shaped sections. Operation 810 may be a process of dividing the work area where the worker works into a plurality of sections in the CCTV image of a workplace by the control server.

The control server may divide the work area in the CCTV image into a plurality of sections by partitioning the work area at a regular interval in the horizontal and vertical directions like a checkerboard, and may assign and display a section number to each section.

For example, the control server may divide the work area in the CCTV image into a plurality of 5×5 sections and assign section numbers (1,1), (1,2), etc. to each of the divided sections (see FIG. 2).

In addition, in operation 820, the control server of the electric ink hard hat system 100 may calculate a complementary color using RGB values in a POI section where the worker is located among the divided sections. Operation 820 may be a process of designating a section where the worker is recognized as a POI section through object recognition in an image by the control server and determining a complementary color contrasting with a dominant color in the POI section.

In calculating the complementary color, the control server may designate representative colors R, G, and B using an average RGB obtained by measuring and averaging RGB values of pixels forming the POI section.

The control server may measure RGB values of all pixels in the POI section using a library, calculate an average R, an average G, and an average B by averaging each of the measured RGB values, and designate each of the average R, the average G, and the average B as the representative colors R, G, and B in the POI section.

In addition, the control server may calculate a complementary color by subtracting each of the designated representative colors R, G, and B from 255, but may calculate the complementary color by rounding the representative colors R, G, and B subtracted from 255 based on 127 by considering a color of which an output is limited by electric ink technology.

That is, the control server may calculate the complementary color by subtracting each of the designated representative colors R, G, and B from 255. However, since all colors may not be expressed by an electric ink, the control server may round the representative colors R, G, and B subtracted from 255 based on 127.

For example, when the representative colors R, G, and B in the POI section are designated through the average RGB, the control server may compare (R<127, G>127, and B<127) each of the representative colors R, G, and B with 127, select R and B less than 127, and accordingly, calculate Purple, which is a color combining R with B, as the complementary color in the POI section.

In addition, when the calculated complementary color is red and overlaps with red depending on a dangerous situation, the control server may recalculate a color by combining a color of the least value among RGB values measured for the POI section with the red as the complementary color.

That is, when the calculated complementary color is red, the control server 110 may replace and recalculate red, which is the complementary color, with other colors to solve the overlapping problem with red that is used to express a dangerous situation. A color combined a color distributed the least in the POI section with the red may be an alternative color.

For example, only R less than 127 should be selected by comparing (R<127, G>127, and B>127) each of the representative colors R, G, and B with 127, but the control server 110 may recalculate Yellow, which is a color combining R with G, as the complementary color in the POI section, by further selecting a relatively less G by comparing (G<B) G with B.

Subsequently, in operation 830, a communication module of the electric ink hard hat system 100 may receive changed color information including the complementary color from the control server. Operation 830 may be a process of receiving changed color information created by the control server from the control server by the communication module mounted on the smart hard hat and transmitting the changed color information to the smart hard hat.

In addition, in operation 840, the smart hard hat of the electric ink hard hat system 100 may output the outer color of the hard hat as the complementary color using electric ink technology, based on the changed color information. Operation 840 may be a process of changing the color of the hard hat to a color contrasting with the work area where the worker is located depending on the complementary color in the changed color information and further identifying the worker by the smart hard hat.

The electric ink technology may be technology for printing a surface of an object while changing a color using electromagnetic properties of particles. In the present disclosure, the electric ink technology may be used to change the outer color of the hard hat worn by the worker to contrast with the work area.

According to an embodiment, the electric ink hard hat system 100 may warn the worker and people around the worker of a dangerous situation by tracking the movement of the worker, recognizing the possibility of the dangerous situation, and changing and then displaying the color of the hard hat as red.

To this end, the position measurement module of the electric ink hard hat system 100 may track the movement of the smart hard hat in the work area by positioning a coordinate value of the smart hard hat in real-time.

The control server may identify a section to which the coordinate value received through the communication module belongs among the sections as the POI section. That is, the control server may assign coordinate values to each of the sections and may designate a section to which the received coordinate values are assigned as the POI section.

In addition, the control server may identify a change of the coordinate value received at a predetermined periodic interval, recognize the movement of the worker wearing the smart hard hat, and accordingly, update and identify the POI section. That is, the control server may identify that there is a change in the received coordinate value, track the movement of the worker, and accordingly, designate the POI section while changing the POI section.

In addition, the control server may determine the worker and a dangerous object in the CCTV image and identify a distance between the worker and the dangerous object, and when the identified distance is in a defined safety distance, the control server may recognize a dangerous situation in the POI section and update the changed color information by replacing the complementary color with red depending on the dangerous situation.

That is, it is determined that the possibility of a dangerous situation is likely to be high as the distance between the worker and the dangerous object is close to each other, and through object recognition on the CCTV image, the control server may create changed color information that changes the smart hard hat to red by replacing the complementary color.

Then, the smart hard hat may change and then output the outer color of the hard hat as red based on the updated changed color information received through the communication module.

That is, the smart hard hat may notify the surroundings that the worker is facing a dangerous situation by changing the color of the hard hat to red indicating a dangerous situation depending on red in the changed color information.

According to an embodiment, by providing the smart hard hat that automatically changes color depending on a surrounding environment of a work area where the worker works in the industrial site, an electric ink hard hat system that changes color depending on a surrounding color and an operating method to easily distinguish the worker from other objects in the work area may be provided.

In addition, according to the present disclosure, it is possible to prevent a collision accident in advance by recognizing a changing color of the smart hard hat through image recognition and identifying a dangerous situation between the worker and a dangerous object in real-time.

In addition, according to the present disclosure, using electric ink technology, when changing the color of the smart hard hat, it is possible to identify the color of the hard hat from all directions compared to the LED-type warning light according to the related art and to reduce power consumption by reducing consumption power compared to LED lighting.

In addition, according to the present disclosure, the smart hard hat to which electric ink technology is applied, which adds various functions without hardware manipulation and is easy to maintain, may be provided.

The methods according to the examples may be recorded in non-transitory computer-readable media including program instructions to implement various operations of the examples. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. An electric ink hard hat system comprising:
a control server configured to divide a work area in a closed-circuit television (CCTV) image into a plurality of grid-shaped sections and calculate a complementary color using red, green, and blue (RGB) values in a point of interest (POI) section where a worker is located among the divided sections:
a communication module configured to receive changed color information comprising the complementary color from the control server; and
a smart hard hat configured to output an outer color of a hard hat as the complementary color using electric ink technology, based on the changed color information.

2. The electric ink hard hat system of claim 1, wherein
the control server is configured to determine the worker and a dangerous object in the CCTV image and identify a distance between the worker and the dangerous object, and when the identified distance is in a defined safety distance, recognize a dangerous situation in the POI section and update the changed color information by replacing the complementary color with red according to the dangerous situation, and
the smart hard hat is configured to change and then output the outer color of the hard hat as red based on the updated changed color information received through the communication module.

3. The electric ink hard hat system of claim 1, wherein the control server is configured to:
designate representative colors R, G, and B using an average RGB obtained by measuring and averaging RGB values of pixels forming the POI section; and
calculate a complementary color by subtracting each of the designated representative colors R, G, and B from 255, but calculate the complementary color by rounding the representative colors R, G, and B subtracted from the 255 based on 127 by considering a color of which an output is limited by the electric ink technology.

4. The electric ink hard hat system of claim 3, wherein, when the calculated complementary color is red and overlaps with red according to the dangerous situation, the control server is configured to recalculate a color by combining a color of the least value among RGB values measured for the POI section with the red as the complementary color.

5. The electric ink hard hat system of claim 1, further comprising:
a position measurement module configured to perform positioning a coordinate value of the smart hard hat,
wherein the control server is configured to:
identify a section to which the coordinate value received through the communication module belongs among the sections as the POI section; and
identify a change of the coordinate value received at a predetermined periodic interval, recognize movement of a worker wearing the smart hard hat, and accordingly, update and identify the POI section.

6. A method of operating an electric ink hard hat system, the method comprising:
dividing a work area in a closed-circuit television (CCTV) image into a plurality of grid-shaped sections by a control server;
calculating a complementary color using red, green, and blue (RGB) values in a point of interest (POI) section where a worker is located among the divided sections by the control server;
receiving changed color information comprising the complementary color from the control server by a communication module; and
outputting an outer color of a hard hat as the complementary color using electric ink technology based on the changed color information, in a smart hard hat.

7. The method of claim 6, further comprising:
determining the worker and a dangerous object in the CCTV image and identifying a distance between the worker and the dangerous object, by the control server;
recognizing a dangerous situation in the POI section when the identified distance is in a defined safety distance and updating the changed color information by replacing the complementary color with red according to the dangerous situation, by the control server; and
changing and outputting the outer color of the hard hat as red based on the updated changed color information received through the communication module, in the smart hard hat.

8. The method of claim 6, wherein the calculating of the complementary color comprises:
designating representative colors R, G, and B using an average RGB obtained by measuring and averaging RGB values of pixels forming the POI section; and
calculating a complementary color by subtracting each of the designated representative colors R, G, and B from 255, but calculating the complementary color by rounding the representative colors R, G, and B subtracted from the 255 based on 127 by considering a color of which an output is limited by the electric ink technology.

9. The method of claim 8, wherein, when the calculated complementary color is red and overlaps with red according to a dangerous situation, the calculating of the complementary color further comprises recalculating a color combined a color of the least value among RGB values measured for the POI section with the red as the complementary color.

10. The method of claim 6, further comprising:
positioning a coordinate value of the smart hard hat by a position measurement module;
identifying a section to which the coordinate value received through the communication module belongs among the sections as the POI section, by the control server; and
identifying a change of the coordinate value received at a predetermined periodic interval, recognizing movement of a worker wearing the smart hard hat, and accordingly, updating and identifying the POI section.
